(19) United States
(12) Patent Application Publication
(10) Pub. No.: US 2022/0033309 A1
(43) Pub. Date: Feb. 3, 2022

(54) ANTIOXIDANTS IN GREEN CERAMIC BODIES CONTAINING VARIOUS OILS FOR IMPROVED FIRING

(71) Applicant: CORNING INCORPORATED, CORNING, NY (US)

(72) Inventors: Robert Joseph Castilone, Painted Post, NY (US); Cecilia Sarah Flynn, Horseheads, NY (US); Mark Alan Lewis, Horseheads, NY (US); William Joseph Murray, Elmira, NY (US); Manivannan Ravichandran, Painted Post, NY (US); Rachel Marie Shaver, Painted Post, NY (US); Molly Kyser Walton, Painted Post, NY (US)

(21) Appl. No.: 17/502,091

(22) Filed: Oct. 15, 2021

Related U.S. Application Data
(63) Continuation of application No. 16/632,016, filed on Jan. 17, 2020.
(60) Provisional application No. 62/536,214, filed on Jul. 24, 2017.

(51) Int. Cl. C04B 35/195; C04B 35/632; C10M 101/02

(52) U.S. Cl. CPC C04B 35/195; C04B 35/632; C10M 101/02; C04B 2235/3206; C04B 2235/9684; C04B 2235/3232; C04B 2235/3481; C04B 2235/6021; C04B 2235/3217

(57) ABSTRACT

Green ceramic mixture for extruding into an extruded green body includes one or more inorganic components selected from the group consisting of ceramic ingredients, inorganic ceramic-forming ingredients, and combinations thereof, at least one mineral oil, and from about 0.01 wt % to about 0.45 wt % of an antioxidant based on a total weight of the inorganic component(s), by super addition. The mineral oil has a kinematic viscosity of ≥about 1.9 cSt at 100° C. The at least one antioxidant may have a degradation-rate peak temperature that is greater than the degradation-rate peak temperature of the at least one mineral oil. In some embodiments, the at least one mineral oil includes greater than about 20 wt % alkanes with greater than 20 carbons, based on a total weight of the at least one mineral oil. Methods of making an unfired extruded body using the batch mixture are also disclosed.

This application is a Continuation of U.S. application Ser. No. 16/632,016 filed on Jul. 24, 2018, which claims the benefit of International Application No. PCT/US2018/043411 filed on Jul. 24, 2018, which claims the benefit of priority under 35 U.S.C. § 119 of U.S. Provisional Application Ser. No. 62/536,214, filed on Jul. 24, 2017, the content of which is relied upon and incorporated herein by reference in its entirety.

### FIELD

The present specification generally relates to the manufacture of ceramic bodies from green ceramic mixtures comprising ceramic and/or ceramic precursor components and, more specifically, to green ceramic mixtures comprising ceramic and/or ceramic precursor components, a mineral oil and an antioxidant, the green ceramic mixture being capable of being formed into green ceramic bodies having improved firing performance.

### TECHNICAL BACKGROUND

Ceramic substrates and filters can be made with organic raw materials that should be removed in the firing process.

### SUMMARY

According to one aspect, a green ceramic mixture for extruding into an extruded green body comprises an inorganic component selected from the group consisting of ceramic ingredients, inorganic ceramic-forming ingredients, and combinations thereof, at least one mineral oil, and from about 0.01 wt % to about 0.45 wt % of an antioxidant based on a total weight of the batch mixture. The at least one mineral oil has a kinematic viscosity of equal to or greater than about 1.9 cSt at 100° C.

According to another aspect, a ceramic precursor batch comprises inorganic ceramic-forming ingredients, at least one mineral oil, and from about 0.01 wt % to about 0.45 wt % of at least one antioxidant. In this aspect, the at least one antioxidant has a degradation-rate peak temperature that is greater than the degradation-rate peak temperature of the at least one mineral oil.

According to yet another aspect, a method of making an unfired extruded body comprises adding at least one mineral oil and at least one antioxidant to one or more ceramic ingredients or inorganic ceramic-forming ingredients. The method further comprises mixing the at least one mineral oil, the at least one antioxidant, and the one or more ceramic ingredients or inorganic ceramic-forming ingredients to form a batch mixture and extruding the batch mixture through a forming die to form a green body. In this aspect, the at least one mineral oil comprises greater than about 20 wt % alkanes with greater than 20 carbons, based on a total weight of the at least one mineral oil.

Additional features and advantages will be set forth in the detailed description which follows, and in part will be readily apparent to those skilled in the art from that description or recognized by practicing the embodiments described herein, comprising the detailed description which follows, the claims, as well as the appended drawings.

It is to be understood that both the foregoing general description and the following detailed description describe various aspects and embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 graphically depicts DSC curves measured at 5° C./minute in air with temperature (° C.) along the x-axis and DSC values (mW/mg) along the y-axis of dried part cores made from green ceramic mixtures according to one or more embodiments described herein;

FIG. 2 graphically depicts the ΔT (° C.; y-axis) as a function of skin temperature (° C.; x-axis) for green ceramic bodies fired in a firing cycle according to one or more embodiments described herein;

FIG. 3 graphically depicts the predicted radial stress (normalized psi; y-axis) as a function of time (hours; x-axis) for green ceramic mixtures according to one or more embodiments described herein;

FIG. 4 graphically depicts the average percentage of cracking (y-axis) observed for green ceramic bodies prepared according to one or more embodiments described herein and fired according to one of two firing cycles (x-axis);

FIG. 5 graphically depicts the maximum temperature achieved during drying with no signs of ignition (represented as bars) and the minimum drying temperature resulting in ignition (represented as “x”s) (y-axis) for various green ceramic mixtures (x-axis) prepared according to one or more embodiments described herein;

FIG. 6 graphically depicts the ΔT (° C.; y-axis) as a function of time (hours; x-axis) for green ceramic mixtures prepared according to one or more embodiments described herein; and

FIGS. 7A and 7B graphically depict the temperature (° C.; y-axis) as a function of time (hours; x-axis) for green ceramic mixtures comprising various amounts of antioxidants prepared according to one or more embodiments described herein.

### DETAILED DESCRIPTION

Reference will now be made in detail to various embodiments of ceramic precursor batches and methods of forming green ceramic bodies using the same. Whenever possible, the same reference numerals will be used throughout the drawings to refer to the same or like parts. The components of the batch mixture may generally comprise inorganic components such as ceramic ingredients or inorganic ceramic-forming ingredients, a mineral oil, and an antioxidant. The batch mixture relies upon the presence of an antioxidant to control the exotherm of the mineral oil during firing. Various embodiments of batch mixtures and methods of forming unfired extruded bodies using the same will be described with specific reference to the appended drawings.

As used herein, the terms “unfired extruded body,” “green body,” “green ceramic body,” or “ceramic green body” refer to an unsintered body, part, or ware before firing, unless otherwise specified. The terms “batch mixture,” “ceramic precursor batch,” “green composition,” and “green batch material” refer to the mixture of materials that are used to form the green body by extrusion, unless otherwise specified. The unfired extruded body and batch mixture contain a vehicle, such as water, and typically comprise inorganic components, and can comprise other materials such as binders, pore formers, stabilizers, plasticizers, and the like. As used herein, “firing” refers to thermal processing of the green body at an elevated temperature to form a ceramic material or a ceramic body.

As used herein, a “wt %,” “weight percent,” or “percent by weight” of an inorganic or organic component, unless specifically stated to the contrary, is based on the total weight of the total inorganics in which the component is included. Organic components are specified herein as super additions based upon 100% of the inorganic components used.

Specific and preferred values disclosed for components, ingredients, additives, reactants, constants, scaling factors, and like aspects, and ranges thereof, are for illustration only. They do not exclude other defined values or other values within defined ranges. The compositions, apparatus, and methods of the disclosure include those having any value or combination of the values, specific values, or ranges thereof described herein.

The batch mixture from which the unfired extruded body is formed comprises at least one inorganic component. The inorganic component may be one or more ceramic ingredient, one or more inorganic ceramic-forming ingredient, and/or combinations thereof. The ceramic ingredient may be, for example, cordierite, aluminum titanate, silicon carbide, mullite, alumina, and the like. The inorganic ceramic-forming ingredient may be cordierite-forming raw materials, aluminum titanate-forming raw materials, silicon carbide-forming raw materials, aluminum oxide-forming raw materials, alumina, silica, magnesia, titania, aluminum-containing constituents, silicon-containing constituents, titanium-containing constituents, and the like.

Cordierite has the formula 2MgO.2Al₂O₃.5SiO₂. The cordierite-forming raw materials may comprise at least one magnesium source, at least one alumina source, at least one silica source, and at least one hydrated clay. In the embodiments described herein, sources of magnesium comprise, but are not limited to, magnesium oxide or other materials having low water solubility that, when fired, convert to MgO, such as Mg(OH)₂, MgCO₃, and combinations thereof. For example, the source of magnesium may be talc (Mg₃Si₄O₁₀(OH)₂), comprising calcined and/or uncalcined talc, and coarse and/or fine talc. In various embodiments, the at least one magnesium source may be present in an amount from about 5 wt % to about 25 wt % of the overall cordierite-forming raw materials on an oxide basis. In other embodiments, the at least one magnesium source may be present in an amount from about 10 wt % to about 20 wt % of the cordierite-forming raw materials on an oxide basis. In further embodiments, the at least one magnesium source may be present in an amount from about 11 wt % to about 17 wt %.

Sources of alumina include, but are not limited to, powders that, when heated to a sufficiently high temperature in the absence of other raw materials, will yield substantially pure aluminum oxide. Examples of suitable alumina sources may comprise alpha-alumina, a transition alumina such as gamma-alumina or rho-alumina, hydrated alumina or aluminum trihydrate, gibbsite, corundum (Al₂O₃), boehmite (AlO(OH)), pseudoboehmite, aluminum hydroxide (Al(OH)₃), aluminum oxyhydroxide, and mixtures thereof. In one embodiment, the at least one alumina source is a kaolin clay, and in another embodiment, the at least one alumina source is not a kaolin clay. The at least one alumina source may be present in an amount from about 25 wt % to about 45 wt % of the overall cordierite-forming raw materials on an oxide basis, for example. In another embodiment, the at least one alumina source may be present in an amount from about 30 wt % to about 40 wt % of the cordierite-forming raw materials on an oxide basis. In a further embodiment, the at least one alumina source may be present in an amount from about 32 wt % to about 38 wt % of the cordierite-forming raw materials on an oxide basis.

Silica may be present in its pure chemical state, such as α-quartz or fused silica. Sources of silica may comprise, but are not limited to, non-crystalline silica, such as fused silica or sol-gel silica, silicone resin, low-alumina substantially alkali-free zeolite, diatomaceous silica, kaolin, and crystalline silica, such as quartz or cristobalite. Additionally, the sources of silica may further include, but are not limited to, silica-forming sources that comprise a compound that forms free silica when heated. For example, silicic acid or a silicon organometallic compound may form free silica when heated. The at least one silica source may be present in an amount from about 40 wt % to about 60 wt % of the overall cordierite-forming raw materials on an oxide basis. In some embodiments, the at least one silica source may be present in an amount from about 45 wt % to about 55 wt % of the cordierite-forming raw materials on an oxide basis. In a further embodiment, the at least one silica source may be present in an amount from about 48 wt % to about 54 wt %.

Hydrated clays used in cordierite-forming raw materials can comprise, by way of example and not limitation, kaolinite (Al₂(Si₂O₅)(OH)₄), halloysite (Al₂(Si₂O₅)(OH)₄.H₂O), pyrophylilite (Al₂(Si₂O₅)(OH)₂), combinations or mixtures thereof, and the like. In some embodiments, the at least one alumina source and at least one silica source are not kaolin clays. In other embodiments, kaolin clays, raw and calcined, may comprise less than 30 wt % or less than 20 wt %, of the cordierite-forming raw materials. The green body may also comprise impurities, such as, for example, CaO, K₂O, Na₂O, and Fe₂O₃.

In some embodiments, the cordierite-forming raw materials have an overall composition comprising, in weight percent on an oxide basis, 5-25 wt % MgO, 40-60 wt % SiO₂, and 25-45 wt % Al₂O₃. In other embodiments, the cordierite-forming raw materials have an overall composition comprising, in weight percent on an oxide basis, 11-17 wt % MgO, 48-54 wt % SiO₂, and 32-38 wt % Al₂O₃.

In embodiments in which the inorganic ceramic-forming ingredients form an aluminum titanate ceramic, the inorganic ceramic-forming ingredients can comprise an alumina source, a silica source, and a titania source. The titania source can in one aspect be a titanium dioxide composition, such as rutile titania, anatase titania, or a combination thereof. The alumina source and silica source may be selected from the sources of alumina and silica described hereinabove. The amounts of the inorganic ceramic-forming ingredients are suitable to provide a sintered phase aluminum titanate ceramic composition comprising, as characterized in an oxide weight percent basis, from about 8 to about 15 wt % SiO₂, from about 45 to about 53 wt % Al₂O₃, and from about 27 to about 33 wt % TiO₂. For example, an exemplary inorganic aluminum titanate precursor powder batch composition can comprise approximately 10% quartz; approximately 47% alumina; approximately 30% titania; and approximately 13% additional inorganic additives. Additional exemplary non-limiting inorganic batch component mixtures suitable for forming aluminum titanate include those disclosed in U.S. Pat. Nos. 4,483,944; 4,855,265; 5,290,739; 6,620,751; 6,942,713; 6,849,181; 7,001,861; and 7,294,164, each of which is hereby incorporated by reference.

In embodiments in which the inorganic components form a silicon carbide ceramic, the inorganic ceramic-forming ingredients can comprise about 10-40%, by weight of the final batch, finely powdered silicon metal, preferably about 15-30%. The silicon powder should exhibit a small mean particle size, e.g., from about 0.2 micron to 50 microns, preferably 1-30 microns. The surface area of the silicon powder may, in some instances, be more descriptive than particle size, and should range between about 0.5 to 10 m²/g, preferably between about 1.0-5.0 m²/g. In various embodiments, the silicon powder is a crystalline silicon powder.

The silicon carbide ceramic-forming batch mixture also contains about 10-40%, by weight, of a carbon precursor, for example, a water soluble crosslinking thermoset resin having a viscosity of less than about 1000 centipoise (cp). The thermoset resin utilized may be a high carbon yield resin in an amount such that the resultant carbon to silicon ratio in the batch mixture is about 12:28 by weight, the stoichiometric ratio of Si—C needed for formation of silicon carbide.

Powdered silicon-containing fillers, in an amount up to 60%, by weight, may also be included in the silicon carbide ceramic-forming batch mixture. The main function of these fillers is to prevent excessive shrinkage of the green body during the carbonization and reactive consolidation/sintering steps. Suitable silicon-containing fillers comprise silicon carbide, silicon nitride, mullite or other refractory materials. Additional exemplary non-limiting inorganic batch component mixtures suitable for forming silicon carbide include those disclosed in U.S. Pat. Nos. 6,555,031 and 6,699,429, each of which is hereby incorporated by reference.

In embodiments in which the inorganic components form an aluminum oxide ceramic, the inorganic components can comprise Al₂O₃ and/or aluminum oxide-forming ingredients.

In addition to the inorganic components, each of the batch compositions disclosed herein comprises one or more organic components (or “organics package”) that comprises at least a mineral oil. In various embodiments, the organics package may also comprise an organic surfactant having a polar head, one or more binders, and/or one or more pore-forming materials. The term “organics package,” as used herein, excludes the amount of solvents, such as water, included in various batch compositions. The organics package is used to form a flowable dispersion that has a relatively high loading of the ceramic material. The mineral oil is chemically compatible with the inorganic components, and provide sufficient strength and stiffness to allow handling of the unfired extruded body. Additionally, the organics package is removable from the unfired extruded body during firing without distorting or breaking the ceramic body. In embodiments, the batch mixtures may have an organics package in percent by weight of the inorganic components, by super addition, from about 1% to about 25% or from about 2% to about 20%. In some embodiments, the batch mixture may have an organics package in percent by weight of the inorganic components, by super addition, from about 5% to about 15%, from about 7% to about 12%, or even from about 9% to about 10%. In some embodiments, the batch mixture may have an organics package in percent by weight of the inorganic components, by super addition, from about 5% to about 11%, or about 7%.

The organics package, in some embodiments, may comprise a binder and at least one pore-forming material. Binders may comprise, but are not limited to, cellulose-containing components such as methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxy methylcellulose, and mixtures thereof. Methylcellulose and/or methylcellulose derivatives, such as hydroxypropyl methylcellulose, are especially suited as organic binders.

Pore-forming materials can comprise, for example, a starch (e.g., corn, barley, bean, potato, rice, tapioca, pea, sago palm, wheat, canna, and walnut shell flour), polymers (e.g., polybutylene, polymethylpentene, polyethylene (preferably beads), polypropylene (preferably beads), polystyrene, polyamides (nylons), epoxies, ABS, acrylics, and polyesters (PET)), hydrogen peroxides, and/or resins, such as phenol resin. In some embodiments, the organic material may comprise at least one pore-forming material. In other embodiments, the organic material may comprise at least two pore-forming materials. In further embodiments, the organic material may comprise at least three pore-forming materials. For example, in embodiments, a combination of a polymer and a starch may be used as the pore former.

The mineral oil provides fluidity to the ceramic precursor batch and aids in shaping the ceramic precursor batch while also allowing the batch to remain sufficiently stiff during the forming (i.e., the extruding) process. The mineral oil can comprise, for example, mineral oils distilled from petroleum, semi-synthetic base oils, including Group II and Group III paraffinic base oils. In various embodiments, the mineral oil is present in an amount of at least 3 wt % of the inorganic components, by super addition. In some embodiments, the mineral oil is present in an amount of from about 3 wt % to about 7 wt % of the inorganic components, by super addition.

In various embodiments, the mineral oil has a kinematic viscosity of equal to or greater than about 1.9 cSt at 100° C. For example, the mineral oil may have a kinematic viscosity of from about 1.9 cSt to about 8.0 cSt at 100° C. or higher. In some embodiments, the mineral oil has a viscosity of from about 2.0 cSt to about 4.0 cSt, from about 2.1 cSt to about 3.0 cSt, or even from about 2.2 cSt to about 2.8 cSt.

In various embodiments, the mineral oil may be characterized by the alkane content of the mineral oil. For example, in some embodiments, the mineral oil is a mixture of alkanes having greater than 10 carbons, and has greater than about 20 wt % alkanes with greater than 20 carbons based on a total weight of the mineral oil. In some embodiments, the mineral oil has greater than about 25 wt % alkanes with greater than 20 carbons, greater than about 30 wt % alkanes with greater than 20 carbons, greater than about 35 wt % alkanes with greater than 20 carbons, greater than about 40 wt % alkanes with greater than 20 carbons, or even greater than about 45 wt % alkanes with greater than 20 carbons. In some embodiments, the mineral oil has a median chain length of greater than 20 carbons, greater than 21 carbons, or greater than 22 carbons.

Organic surfactants having a polar head adsorb to the inorganic particles, keeping the inorganic particles in suspension, preventing clumping, and may generate migration pathways, as described in greater detail hereinbelow. The organic surfactant can comprise, for example, C₈-C₂₂ fatty acids and/or their ester or alcohol derivatives, such as stearic, lauric, linoleic, oleic, myristic, palmitic, and palmitoleic acids, soy lecithin, and mixtures thereof. Accordingly, as used herein, the terms “organic surfactants having a polar head,” “organic surfactants,” and “fatty acids” may be used interchangeably. In various embodiments, the organic surfactant is present in an amount of at least 0.3 wt % of the inorganic components, by super addition. In some embodiments, the organic surfactant is present in an amount of from about 0.5 wt % to about 3 wt % of the inorganic components, by super addition.

In various embodiments, the amount of mineral oil and the amount of organic surfactant may be varied to achieve a desired amount of wall drag as the batch mixture is extruded through the extrusion die. Additional details on varying the amounts of mineral oil and organic surfactant may be found, for example in U.S. Patent Application Publication No. 2016/0289123, filed on Mar. 30, 2015 and entitled “Ceramic Batch Mixtures Having Decreased Wall Drag,” the entire contents of which is hereby incorporated by reference. ¶ Organic materials which may be contained in binders (methocel, polyvinyl alcohol, etc.), lubricants, dispersants, or pore formers such as starch, graphite, and other polymers, may be burned out in the presence of oxygen at temperatures above their flash points. Some of these materials may also be removed as volatile organic compounds (VOC) upon burning in a kiln and/or in an after treatment apparatus, such as a thermal oxidizer. The decomposition and/or oxidation of these materials usually release heat and often influence shrinkage or growth of a body formed from the mixture of materials, which may cause stresses and ultimately lead to cracking in the body.

In various embodiments, the antioxidant is added to the batch mixture to delay or control the onset of oxidation of organics (e.g., the binders, surfactants, and mineral oils referred to above) during the firing cycle. For example, the antioxidant may be used to adjust the onset of oxidation of the organics in order to enable multiple compositions to be fired using the same firing cycle, as will be described in greater detail below. As another example, the antioxidant may be used to delay the oxidation of the organics to delay the onset of oxidation such that the organic compounds evaporate or thermally decompose rather than oxidizing during the firing cycle. Without being bound by theory, it is believed that the antioxidants act as a temporary hindrance to the oxidation of organics, such as the mineral oil and the organic surfactant, during firing of the ceramic green bodies. They can be removed during the later period of the firing cycle, or some element in them can remain in the body so long as they do not impose adverse effects on properties, including but not limited to thermal expansion and strength, of the fired body. By delaying the onset of exothermic oxidation, various organic compounds, including the mineral oil, are allowed to either evaporate or thermally decompose. Because both evaporation and thermal decomposition are endothermic reactions, the net heat production caused by oxidation is significantly reduced, which in turn reduces temperature gradients and may reduce cracking.

Various approaches to antioxidation are related to delaying the initiation and controlling the formation of peroxides, one of the main oxidation products of organics at the early stage of firing. However, the exact functions of antioxidants depend on the particular type and structure of the antioxidant.

In some embodiments, the antioxidant comprises a free-radical trapper, a peroxide decomposer, and/or a metal deactivator. In various embodiments the antioxidant is a phenolic antioxidant, such as a hindered phenol, a secondary amine, an organosulfur compound, a trivalent phosphorous compound, a selenium compound, and/or an aryl derivative of tin. In particular embodiments, the antioxidant is a hindered phenolic antioxidant with a preference for oil solubility versus water solubility. The antioxidant may be, for example, triphenylmethylmercaptan, 2-mercaptobenzothiozole, 2,6-di-t-butyl-4-methylphenyl, 2,4,6-trimethylphenyl, butylated octylated phenyl, butylated di(dimethylbenzyl)phenol, and/or 1:11 (3,6,9-trioxaudecyl)bis-(dodecylthio)propionate, or a combination thereof.

Hindered phenols and aromatic amines act as radical scavengers. Radical-scavenging antioxidants (also called radical trappers) act by donating a hydrogen atom to the peroxy radical, ROO. This breaks the self-propagating chain and forms A, a stable radical:

ROO,+AH→ROOH+A,

ROO,+A,→inert products

2A,→inert products

Some suitable hindered phenols and aromatic amines are monophenols such as 2,6-di-tert-butylphenol, 2,6-di-tert-butyl-4-methylphenol, 2,6-di-tert-butyl-4-sec-butylphenol; biphenols such as 4,4′-methylene bis (2,6-di-tert-butyl phenol); 4,4′-Thiobis-(2-methyl-6-tert-butylphenol, and thiodiethylene bis-(3,5-di-tert-butyl-4-hydroxy)hydrocinnamate; polyphenols such as tetrakis(methylene (3,5-di-tert-butyl-4-hydroxydrocinnamate)methane, and aromatic amines such as N-phenyl-I-naphthylamine, p-oriented styrenated diphenylamine, octylated diphenylamines; alkylated p-phenylenediamines, and N-phenyl-N′-(1,3-dimethyl-butyl)-p-phenylenediamine.

Organic sulfur and phosphorus compounds act as peroxide decomposers generally according to the following generic mechanism:

RSR+R′OOH→RS(O)R+R′OH

RSSR+R′OOH→RS(O)SR+R′OH

Divalent and tetravalent sulfur such as organic sulfides and disulfides are generally more effective than hexavalent compounds. Elementary sulfur is an effective oxidant inhibitor. Sulfurized esters, terpenes, resins, and polybutenes; dialkyl sulfides, polysulfides, diaryl sulfides, thiols, mercaptobenzimidazoles, thiophenes, xanthogenates, thioaldehydes, and others can also be utilized as oxidation inhibitors as well.

Selenium compounds such as dilauryl selenides have also shown good performance as oxidation inhibitors, even better than the corresponding sulfides in the sense that they do not produce unwanted acidic products.

Metal salts of dithiocarbonic and thiophosphoric acids can be used. One example of the latter is zinc dialkyldithiophosphate Zn(PROR′OS₂)₂. Some R and R′ groups that can be utilized (respectively) in zinc dialkyldithiophosphates are C₃-C₁₀ primary and secondary alkyl groups.

Some suitable organotin compounds are aryl derivatives of tin, and dibutyltin laurate.

In various embodiments, the various classes of antioxidants can be used together to create a synergistic effect. For example, phenols may be added as main components and a small amount of organosulfur compounds may be added as promotor. The antioxidants in a synergistic system function by different mechanisms so that their combined effect is greater than their sum.

In various embodiments, the antioxidant is in a liquid form, usually a viscous liquid. The benefits of using liquid antioxidants are three fold, in addition to their normal role as antioxidants. First, it allows a reduction of total organic non-solvent amount, while still maintaining the lubricity, stiffness and green strength characteristics of the green extrudates. This subsequently brings about a reduction of total heat generated by oxidation due to the reduction of the hydrocarbons entering the kiln. Second, it allows a reduction of water content (used as a solvent for the binder). This in turn produces a stiffer and stronger batch as is described in the previous sections. Third, liquid antioxidants can be easily mixed with the oils (non-solvents) that are used to achieve the desired stiffness for the batch.

Some especially useful antioxidants are phenolic compounds under the name of butylated octylated phenol and butylated di(dimethylbenzyl) phenol, an organosulfur compound under the name of 1:11 (3,6,9-trioxaudecyo)bis-(dodecylthio)propionate, all manufactured by Goodyear Tire. Butylated oxylated phenols have an average molecular weight of 260-374, butylated di(dimethylbenzyl) phenol has an average molecular weight of 386, and 1:11 (3,6,9-trioxaudecyl(bis-dodecylthio)propionate has an average molecular weight of 884-706. In some particular embodiments, the antioxidant is a benzene propanoic acid.

In various embodiments, the antioxidant has a thermal degradation-rate peak temperature that is greater than the thermal degradation-rate peak temperature of the mineral oil. This ensures that the antioxidant remains in the batch mixture and is actively working to prevent oxidation of the mineral oil while the mineral oil remains present. For example, in some embodiments, the mineral oil has a thermal degradation-rate peak temperature that is between about 220° C. and about 240° C., and the antioxidant has a thermal degradation-rate peak temperature between about 260° C. and about 280° C.

In various embodiments, the antioxidant is included in the batch mixture in an amount of about 0.01 wt % to about 0.45 wt %, from about 0.02 wt % to about 0.4 wt %, from about 0.01 wt % to about 0.26 wt %, or even from about 0.2 wt % to about 0.4 wt % based on the inorganic components, by super addition. For example, the antioxidant may be included in about 0.01 wt %, 0.02 wt %, 0.03 wt %, 0.05 wt %, 0.08 wt %, 0.10 wt %, 0.15 wt %, 0.20 wt %, 0.25 wt %, 0.30 wt %, 0.35 wt %, or even 0.40 wt % based on the inorganic components, by super addition. It is contemplated that the particular amount of antioxidant included in the batch composition may be selected based on one or more of the firing cycle to be employed, the cell geometry of the honeycomb, the size of the extruded part, the amount of mineral oil and organic surfactant in the batch mixture, or the like.

In various embodiments, solvents may be added to the batch mixture to create a ceramic paste (precursor or otherwise) from which the unfired extruded body is formed. In embodiments, the solvents may comprise aqueous-based solvents, such as water or water-miscible solvents. In some embodiments, the solvent is water. The amount of aqueous solvent present in the ceramic precursor batch may range from about 20 wt % to about 50 wt %.

According to various embodiments, a method of making a ceramic body comprises adding the organics package (comprising at least a mineral oil) and an antioxidant to at least one inorganic component. The inorganic components and organic materials may be mixed to form a batch mixture. The batch mixture may be made by conventional techniques. By way of example, the inorganic components may be combined as powdered materials and intimately mixed to form a substantially homogeneous batch. The organic materials, antioxidant, and/or solvent may be mixed with inorganic components individually, in any order, or together to form a substantially homogeneous batch. Of course, other suitable steps and conditions for combining and/or mixing inorganic components and organic materials together to produce a substantially homogeneous batch may be used. For example, the inorganic components and organic materials may be mixed by a kneading process to form a substantially homogeneous batch mixture.

In various embodiments, the batch mixture is shaped or formed into a structure using conventional forming means, such as molding, pressing, casting, extrusion, and the like. According to various embodiments, the batch mixture is extruded to form a green body. Extrusion can be achieved using a hydraulic ram extrusion press, a two stage de-airing single auger extruder, or a twin screw mixer with a die assembly attached to the discharge end of the extruder. The batch mixture may be extruded at a predetermined temperature and velocity.

In various embodiments, the batch mixture is formed into a honeycomb structure. The honeycomb structure may comprise a web structure having a plurality of cells separated by cell walls. In some embodiments, each of the cell walls has a thickness of less than about 0.005 inch. Such thin-walled honeycomb structures may be susceptible to distortion resulting from, among other things, differential shear or flow of the batch mixture through the extrusion die and/or interactions between the extrusion die and the batch materials.

After formation, the unfired extruded body is then fired at a selected temperature under suitable atmosphere and for a time dependent upon the composition, size, and geometry of the green body to result in a fired, porous ceramic body. Firing times and temperatures depend on factors such as the composition and amount of material in the green body and the type of equipment used to fire the green body. Firing temperatures for forming cordierite may range from about 1300° C. up to about 1450° C., with holding times at the peak temperatures ranging from about 1 hour to about 15 hours and total firing times that may range from about 20 hours up to about 200 hours. Suitable firing processes may include those described in U.S. Pat. Nos. 8,187,525, 6,287,509, 6,099,793, or U.S. Pat. No. 6,537,481, each of which is incorporated by reference in its entirety. When fired to form a ceramic body, the honeycomb structures can be used as particulate filters in internal combustion systems, for example.

In various embodiments, the organic materials, including the mineral oil, are burned from the green body during the firing cycle. Burning of organic materials can include both organic material and partially decomposed organic material (i.e., char). During the burning of organic materials, char formation occurs when partially decomposed organic materials (i.e., char) and volatiles are formed and char removal occurs when the char is burned off Char can increase the stiffness (elastic modulus) of the green body, and when present in the core portion of the green body, the core portion can be four times the stiffness of the skin portion. The differential in stiffness between the core portion and the skin portion can substantially increase and/or amplify stresses present in the green body, thereby leading to cracking. Ultimately, the combination of temperature differentials between the temperature of the core portion and the temperature of the skin portion and chemistry differentials (i.e., char present in the core portion) lead to shrinkage and stiffness that causes cracking from high stresses. Accordingly, the inclusion of the antioxidant can enable the mineral oil to either evaporate or thermally decompose rather than oxidizing and burning, which reduces the amount of char, which in turn enables the char to be removed prior to clay water loss shrinkage, reducing or even minimizing stresses during firing and decreasing cracking.

In various embodiments, the amount of antioxidant can be varied to enable various compositions to be fired in a kiln using the same firing cycle. By varying the amount of antioxidant in each composition, the oxidation events of each composition can be targeted and maintained in a narrow temperature range, which may enable optimization of the debind portion of the firing cycle.

According to various embodiments, a method of making an unfired extruded body comprises adding the organics package (including at least one mineral oil) and the antioxidant to inorganic components (e.g., one or more ceramic ingredients and/or the inorganic ceramic-forming ingredients), mixing the ingredients to form a batch mixture, and extruding the batch mixture through a forming die to form a green body.

### EXAMPLES

It is believed that the various embodiments described hereinabove will be further clarified by the following examples.

### Example 1

A series of batch mixtures having different concentrations of oils and antioxidants were prepared and tested using differential scanning calorimetry (DSC) measured at 5° C./minute. Each batch mixture included the same inorganic components in the form of cordierite-forming raw materials having an overall composition comprising, in weight percent on an oxide basis, 5-25 wt % MgO, 40-60 wt % SiO₂, and 25-45 wt % Al₂O₃ and a varying organics package and antioxidant amount. Each batch mixture further included from 0.5 wt % to about 1.0 wt % total fatty acid, based on a total weight of inorganics, by super addition. The organics package and antioxidants for each of the batch mixtures are summarized in Table 1. In particular, each of Comparative Samples A and B included a lubricant without antioxidant. Comparative Sample A included a polyalphaolefin (PAO) having a kinematic viscosity of about 1.8 cSt at 100° C. and including greater than about 90 wt % C₂₀ alkanes. Comparative Sample B included a Group II+ mineral oil having a kinematic viscosity of 2.0 cSt at 100° C. and including greater than 20 wt % alkanes with greater than 20 carbons based on a total weight of the mineral oil. Samples 1 and 2 included the Group II+ mineral oil having a kinematic viscosity of 2.0 cSt at 100° C. and including greater than 20 wt % alkanes with greater than 20 carbons based on a total weight of the mineral oil and either 0.2 wt % (Sample 1) or 0.4 wt % (Sample 2) of a hindered phenolic antioxidant with a preference for oil solubility versus water solubility.

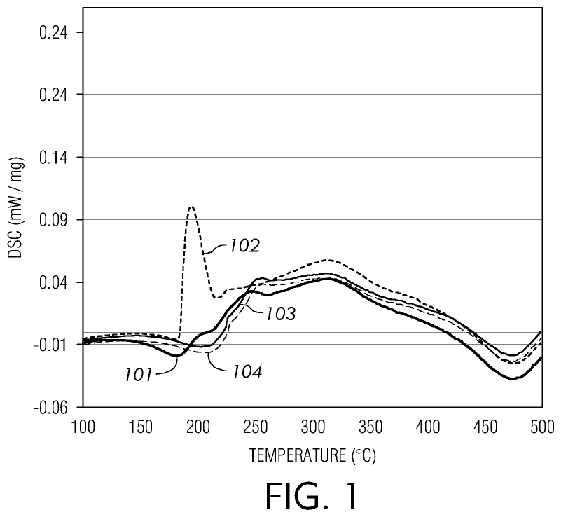

The results are shown in FIG. 1.

TABLE 1
Batch Compositions, expressed in wt %,
by super addition

| | Comparative | Comparative | Sample | Sample |
|---|---|---|---|---|
| | Sample A | Sample B | 1 | 2 |
| PAO | 6.0 | 0 | 0 | 0 |
| Group II + | 0 | 6.0 | 6.0 | 6.0 |
| mineral oil | | | | |
| Antioxidant | 0 | 0 | 0.2 | 0.4 |

In particular, FIG. 1 is shows the resultant DSC curves measured at 5° C./minute in air, of dried part cores made from the batch mixtures of Table 1. Notably, Comparative Sample B (curve 102) exhibits a large DSC oil exotherm at approximately 190° C. that is not present when the PAO is used as the lubricant (Comparative Sample A; curve 101). However, the super-additions of either 0.2 wt % (Sample 1; curve 103) or 0.4 wt % (Sample 2; curve 104) of the antioxidant results in DSC curves similar to that of Comparative Sample A. In other words, the inclusion of antioxidant with the mineral oil is sufficient to eliminate the exotherm at approximately 190° C.

### Example 2

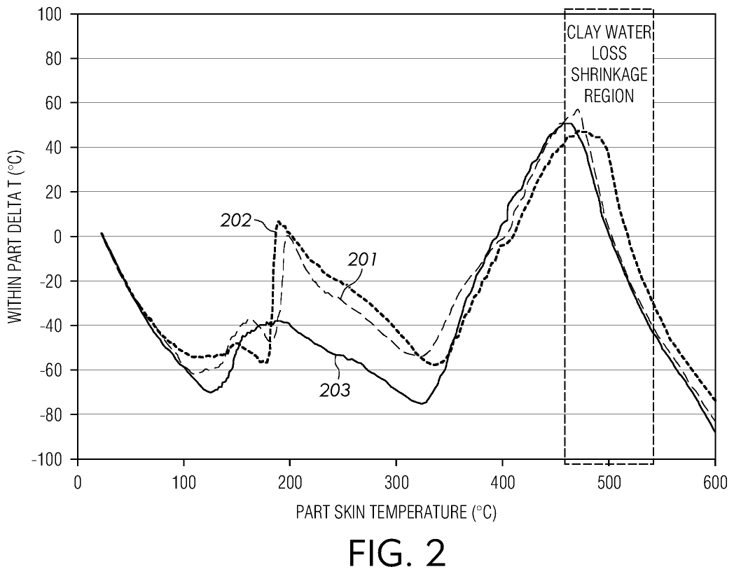

The batch mixtures of Comparative Samples A and B and Sample 1 were extruded to prepare green ceramic bodies approximately 13.9 inches in diameter and 8.4 inches in height and having 300 cells/in² and a wall thickness of approximately 0.005 inches. Each of the green ceramic bodies was coupled with a mid-core thermocouple and a skin thermocouple, and fired in a firing cycle. The difference in temperature (ΔT) for each sample is depicted in FIG. 2.

As shown in FIG. 2, the inclusion of the antioxidant with the mineral oil eliminates the exothermic reaction in the cores of the parts, as demonstrated by the decrease in ΔT of observed in Sample 1 (curve 203) as compared to Comparative Samples A and B (curves 201 and 202, respectively) at a skin temperature of about 200° C. This reinforces what was expected based on the DSC data obtained in the previous example.

Moreover, FIG. 2 shows that the inclusion of mineral oil in Comparative Sample B results in a delayed exotherm (represented by the shift of the peak to the right near 500° C.), which is associated with char. In particular, the shift of the exotherm into the clay water loss shrinkage region (from about 450° C. to about 550° C.) indicates that the temperature necessary to burn off the char formed during the firing of Comparative Sample B would additionally result in shrinkage of the log. However, Sample 1 shows a significant decrease in the exothermic reaction associated with char burning, which can reduce the stress in the part and lead to lower temperature burnout of the char, thereby minimizing the overlap with clay shrinkage. In other words, the char formed in Sample 1 can be burned off during firing prior to the part experiencing clay shrinkage.

### Example 3

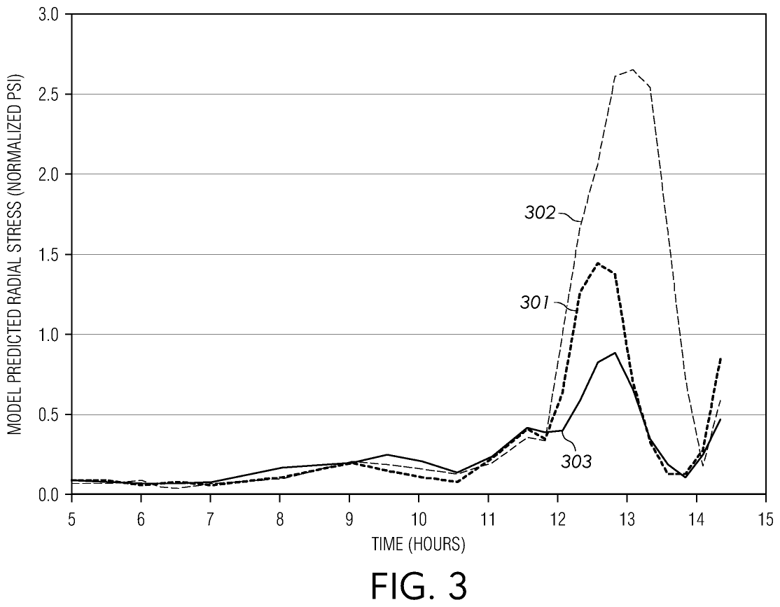

A mathematical model to estimate the stress over the firing cycle was then used to estimate the stresses experienced by Comparative Samples A and B and Sample 1. In particular, the model uses input strength and shrinkage parameters and applies the thermocouple data collected in Example 2 to estimate a failure stress for articles formed from the different green ceramic mixtures. The results of the modeling are shown in FIG. 3.

Consistent with the results of Examples 1 and 2, the modeling predicted a significant increase in stress for Comparative Sample B (curve 302), including mineral oil alone, as compared to Comparative Sample A (curve 301), which included polyalphaolefin (PAO) having a kinematic viscosity of about 1.8 cSt at 100° C. and including greater than about 90 wt % C₂₀ alkanes, primarily due to the interaction with the extended char exothermic reaction with clay shrinkage, as shown in FIG. 2. FIG. 3 also depicts a significant reduction in the stress when 0.2% antioxidant is added along with mineral oil in Sample 1 (curve 303). Advantageously, the modeling demonstrated a decrease in stress in Sample 1 as compared to Comparative Sample A.

### Example 4

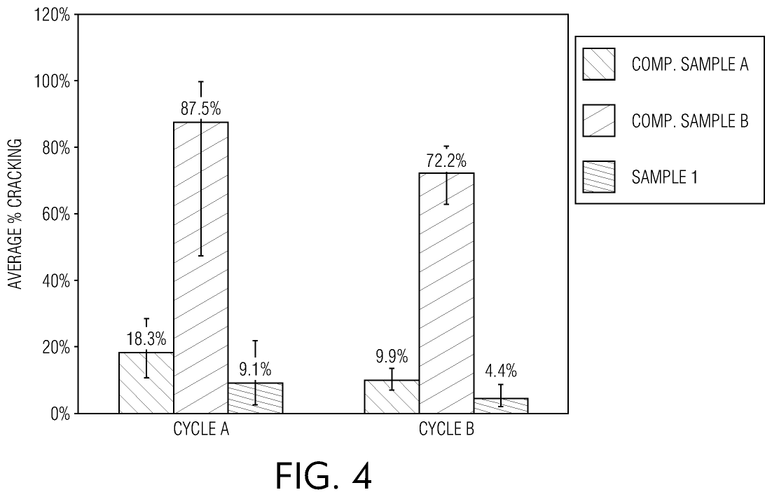

The batch mixtures of Comparative Samples A and B and Sample 1 were extruded to prepare green ceramic bodies approximately 13.9 inches in diameter and 8.4 inches in height and having 300 cells/in² and a wall thickness of approximately 0.005 inches. The green ceramic bodies were fired in one of two firing cycles, and the crack rates were recorded. The results are depicted in FIG. 4.

As can be seen in FIG. 4, Comparative Sample B, including mineral oil, exhibited significantly higher crack rates during both firing cycles. However, the addition of the antioxidant brought the crack rates for Sample 1 down to at or below the crack rates for Comparative Sample A. In particular, Sample 1 demonstrated significantly lower crack rates compared to Comparative Sample A for firing cycle A, while the lower crack rates for Sample 1 were not statistically significant.

### Example 5

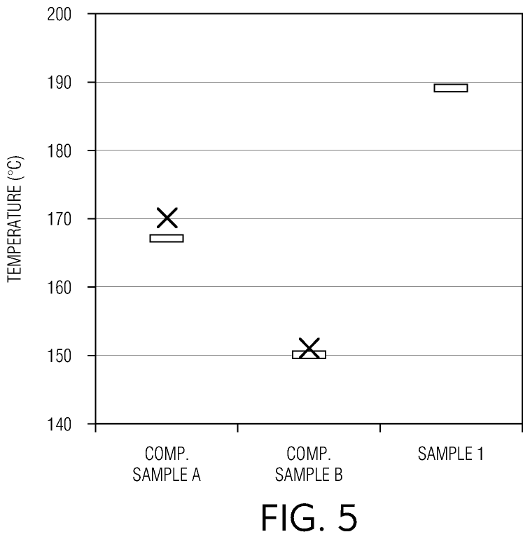

Extruded logs formed from the batch mixtures identified above were heated in a 915 MHz microwave dryer to specific temperatures. Log temperatures were checked using probes in multiple locations to determine the peak temperature achieved during and immediately following heating. Internal log temperatures were monitored until the log showed continuous cooling or heating. The peak temperature was recorded, and the results are shown in FIG. 5.

As shown in FIG. 5, Comparative Sample A exhibited a maximum temperature of approximately 167° C. during drying with no signs of ignition. This temperature decreased to approximately 150° C. for Comparative Sample B. For Comparative Sample A, a temperature of 170° C. resulted in ignition of the log. For Comparative Sample B, a temperature of 151° C. resulted in ignition of the log. However, the maximum temperature achieved during drying for Sample 1 was 189° C., which was the highest temperature tested, and no tested temperature resulted in ignition. Without being bound by theory, it was believed that if the temperatures began to continuously rise again after the heat source was removed, an exothermic burning event was occurring. Accordingly, based on the results of Example 5, it was discovered that the combination of mineral oil and antioxidant could raise the allowable drying temperature of the logs by at least 39° C. Without being bound by theory, it is believed that a higher allowable drying temperature can reduce the likelihood of drying-related fires and may additionally allow for higher drying temperatures in difficult to dry compositions.

### Example 6

Having demonstrated that a combination of mineral oil and antioxidant was effective to reduce or eliminate the exothermal peak in green ceramic mixtures having a relatively high amount of oil (approximately 6 wt % based on a total weight of inorganics by super addition), additional experiments were conducted to confirm the efficacy of the combination of mineral oil and antioxidant on green ceramic mixtures including lower amounts of mineral oil and higher amounts of fatty acids.

Specifically, each batch mixture included the inorganic components in the form of cordierite-forming raw materials having an overall composition comprising, in weight percent on an oxide basis, 5-25 wt % MgO, 40-60 wt % SiO₂, and 25-45 wt % Al₂O₃ and a varying organics package and antioxidant amount. Each batch mixture further included from 0.5 wt % to about 2.0 wt % total fatty acid, based on a total weight of inorganics, by super addition. In particular, Comparative Sample C included a lubricant, a polyalphaolefin (PAO) having a kinematic viscosity of about 1.8 cSt at 100° C. and including greater than about 90 wt % C₂₀ alkanes, without antioxidant. Sample 3 included a Group II+ mineral oil having a kinematic viscosity of 2.0 cSt at 100° C. and including greater than 20 wt % alkanes with greater than 20 carbons based on a total weight of the mineral oil and a hindered phenolic antioxidant with a preference for oil solubility versus water solubility. Sample 3 included mineral oil and antioxidant at a ratio of 30:1 (mineral oil:antioxidant) by weight, and approximately 0.21 wt % antioxidant based on a total weight of inorganics, by super addition.

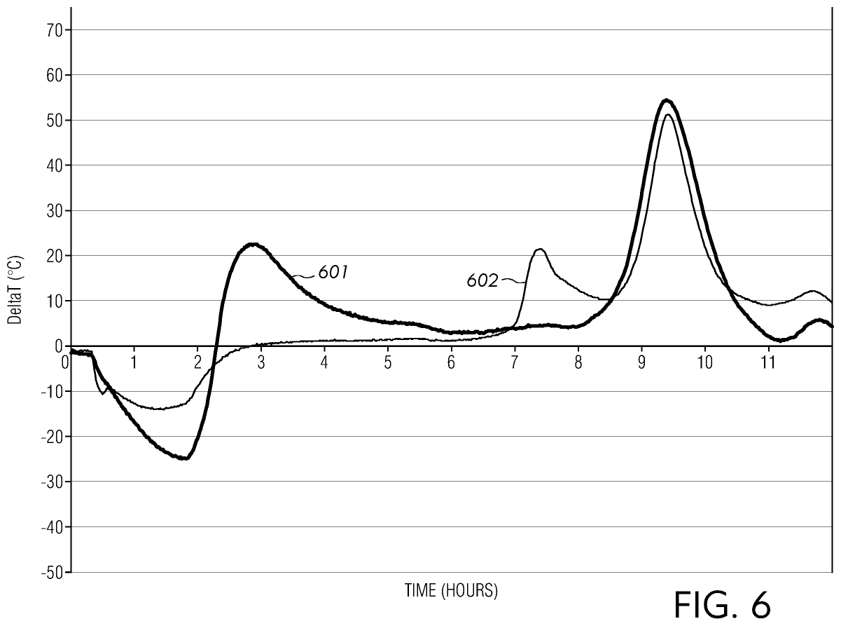

The green ceramic mixtures were extruded into green honeycomb parts and fired according to a firing cycle, while the thermal responses were measured. The within-part temperature gradients (ΔT) are shown in FIG. 6.

As shown in FIG. 6, the inclusion of the antioxidant in Sample 3 resulted in a shift in the thermal peak (curve 602) from a time of nearly 3 hours (Comparative Sample C; curve 601) to a time of just over 7 hours (Sample 3). Practically, this indicates that if wares formed from these batch compositions were to be fired together in the same firing cycle, the firing cycle, and particularly the debind portion of the firing cycle, would need to be slowed until the thermal peak of Sample 3, resulting in significantly longer firing cycle than if the wares formed of Comparative Sample C were fired alone.

Accordingly, it was hypothesized that the amount of antioxidant included in the batch mixture could be used to tune the thermal response in order to align the responses of various batch mixtures and to achieve similar timing.

### Example 7

Various amounts of antioxidants were added to different batch mixture compositions to determine the effect of varying the amount of the composition. Specifically, each batch mixture included the inorganic components in the form of cordierite-forming raw materials having an overall composition comprising, in weight percent on an oxide basis, 5-25 wt % MgO, 40-60 wt % SiO₂, and 25-45 wt % Al₂O₃ and a varying organics package and antioxidant amount. The inorganics package was one of two specific packages, as indicated in Table 2 below. Each batch mixture further included from 0.5 wt % to about 2.0 wt % total fatty acid, based on a total weight of inorganics, by super addition. Each sample included a Group II+ mineral oil having a kinematic viscosity of 2.0 cSt at 100° C. and including greater than 20 wt % alkanes with greater than 20 carbons based on a total weight of the mineral oil and a hindered phenolic antioxidant with a preference for oil solubility versus water solubility. The amounts included in each batch mixture are reported in Table 2.

TABLE 2
Batch Compositions,
expressed in wt %, by super addition

| | Inorganics | |
|---|---|---|
| | Package | Antioxidant |
| Sample 4 | A | 0.21 |
| Sample 5 | A | 0.21 |
| Sample 6 | A | 0.13 |
| Sample 7 | A | 0.10 |
| Sample 8 | A | 0.08 |
| Sample 9 | B | 0.13 |
| Sample 10 | B | 0.13 |
| Sample 11 | B | 0.26 |
| Sample 12 | B | 0.43 |
| Sample 13 | B | 0.84 |

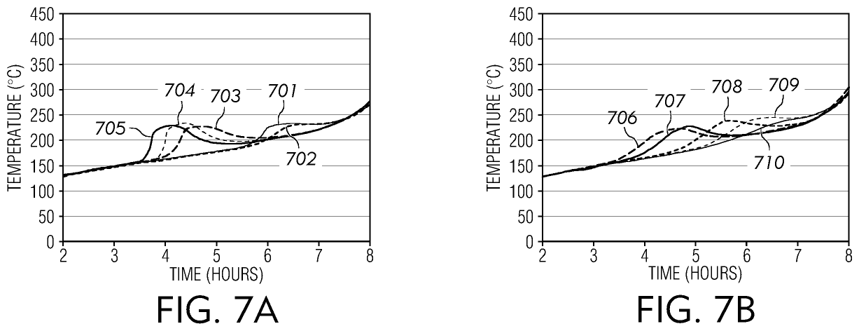

Thermal analysis was conducted on ceramic green bodies prepared from each of the batch mixtures of Samples 4-13. Specifically, thermocouples were used to measure the temperatures of the ceramic green bodies during firing to identify midcore thermal responses. The results are shown in FIGS. 7A and 7B.

FIG. 7A demonstrates that decreasing the amount of antioxidant below about 0.21 wt % can hasten the first thermal event, as indicated by the peaks for each of the samples. In FIG. 7A, Sample 4 corresponds to curve 701, Sample 5 corresponds to curve 702, Sample 6 corresponds to curve 703, Sample 7 corresponds to curve 704, and Sample 8 corresponds to curve 705. As the amount of antioxidant in the green ceramic mixture is decreased, the peak corresponding to the first thermal event shifts to the left. Similarly, FIG. 7B demonstrates that increasing the amount of antioxidant can delay the first thermal event. In FIG. 7B, Sample 9 corresponds to curve 706, Sample 10 corresponds to curve 707, Sample 11 corresponds to curve 708, Sample 12 corresponds to curve 709, and Sample 13 corresponds to curve 710. As the amount of antioxidant in the green ceramic mixture is increased, the peak corresponding to the first thermal event shifts to the right.

It should now be understood that embodiments of the present disclosure enable a mineral oil to be used as a lubricant by including an amount of antioxidant in the green ceramic mixture without increasing the likelihood of cracking or ignition during firing or drying.

Further, various embodiments enable the thermal event, or exothermic peak, of a green ceramic mixture to be controlled or even eliminated, depending on the particular amount of antioxidant and the overall batch mixture composition. The ability to control the thermal events can provide process benefits and reductions in cost. For example, the ability to control the timing of the thermal events can enable parts made from various green ceramic mixtures to be fired during the same firing cycle, and may further enable optimization and shortening of the firing cycle. Other advantages will be appreciated by one skilled in the art.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of making porous ceramic bodies, the method comprising:
mixing at least one mineral oil, at least one antioxidant, and one or more ceramic ingredients or inorganic ceramic-forming ingredients to form a first batch mixture;
extruding the first batch mixture to form a first green body;
mixing at least one mineral oil, at least one antioxidant, and one or more ceramic ingredients or inorganic ceramic-forming ingredients to form a second batch mixture;
extruding the second batch mixture to form a second green body;
firing the first green honeycomb body in a kiln according to a first firing cycle for a first total firing time sufficient to produce a first porous ceramic body;
firing the second green body in a kiln according to a second firing cycle for a second total firing time sufficient to produce a second porous ceramic body;
wherein the first and second green bodies differ in composition, size, and/or geometry of the respective green body;
wherein the amount of antioxidant included in each respective batch mixture is selected such that the first total firing time is the same as the second total firing time.

2. The method of claim 1 wherein the at least one mineral oil includes greater than about 20 wt % alkanes with greater than 20 carbons based on a total weight of the at least one mineral oil.

3. The method of claim 1 wherein the at least one antioxidant is present at about 0.01 wt % to about 0.45 wt %, by super addition, to the one or more ceramic ingredients or inorganic ceramic-forming ingredients.

4. The method of claim 1 wherein the at least one mineral oil has a kinematic viscosity of equal to or greater than about 1.9 cSt at 100° C.

5. The method of claim 1 wherein the at least one antioxidant has a thermal degradation-rate peak temperature that is greater than a thermal degradation-rate peak temperature of the at least one mineral oil.

6. A method of making porous ceramic bodies, the method comprising:
mixing at least one mineral oil, at least one antioxidant, and one or more ceramic ingredients or inorganic ceramic-forming ingredients to form a first batch mixture;
extruding the first batch mixture to form a first green body;
mixing at least one mineral oil, at least one antioxidant, and one or more ceramic ingredients or inorganic ceramic-forming ingredients to form a second batch mixture;
extruding the second batch mixture to form a second green body;
firing the first green honeycomb body in a kiln according to a first firing cycle for a first total firing time sufficient to produce a first porous ceramic body;
firing the second green honeycomb body in a kiln according to a second firing cycle for a second total firing time sufficient to produce a second porous ceramic body;
wherein the first and second green honeycomb bodies differ in composition, size, and/or geometry of the respective green body;
wherein the amount of antioxidant included in each respective batch mixture is selected such that the thermal peak responses of the respective batch mixtures are aligned with each other.

7. The method of claim 6 wherein the at least one mineral oil includes greater than about 20 wt % alkanes with greater than 20 carbons based on a total weight of the at least one mineral oil.

8. The method of claim 6 wherein the at least one antioxidant is present at about 0.01 wt % to about 0.45 wt %, by super addition, to the one or more ceramic ingredients or inorganic ceramic-forming ingredients.

9. The method of claim 6 wherein the at least one mineral oil has a kinematic viscosity of equal to or greater than about 1.9 cSt at 100° C.

10. The method of claim 6 wherein the at least one antioxidant has a thermal degradation-rate peak temperature that is greater than a thermal degradation-rate peak temperature of the at least one mineral oil.

11. A method of making porous ceramic bodies, the method comprising:
mixing at least one mineral oil, at least one antioxidant, and one or more ceramic ingredients or inorganic ceramic-forming ingredients to form a first batch mixture;
extruding the first batch mixture to form a first green body;
mixing at least one mineral oil, at least one antioxidant, and one or more ceramic ingredients or inorganic ceramic-forming ingredients to form a second batch mixture;
extruding the second batch mixture to form a second green body;
firing the first green honeycomb body in a kiln according to a first firing cycle for a first total firing time sufficient to produce a first porous ceramic body;
firing the second green honeycomb body in a kiln according to a second firing cycle for a second total firing time sufficient to produce a second porous ceramic body;
wherein the first and second green honeycomb bodies differ in composition, size, and/or geometry of the respective green body;
wherein the amount of antioxidant included in each respective batch mixture is selected such that a timing of a first thermal event of the respective batch mixtures occurring in the respective firing cycles are adjusted.

12. The method of claim 11 wherein the at least one mineral oil includes greater than about 20 wt % alkanes with greater than 20 carbons based on a total weight of the at least one mineral oil.

13. The method of claim 11 wherein the at least one antioxidant is present at about 0.01 wt % to about 0.45 wt %, by super addition, to the one or more ceramic ingredients or inorganic ceramic-forming ingredients.

14. The method of claim 11 wherein the at least one mineral oil has a kinematic viscosity of equal to or greater than about 1.9 cSt at 100° C.

15. The method of claim 11 wherein the at least one antioxidant has a thermal degradation-rate peak temperature that is greater than a thermal degradation-rate peak temperature of the at least one mineral oil.
